(19) United States
(12) Patent Application Publication
(10) Pub. No.: US 2026/0369205 A1
(43) Pub. Date: Nov. 19, 2026

(54) DISPLAY DEVICE

(71) Applicant: LG Display Co., Ltd., Seoul (KR)

(72) Inventor: SeungTaek OH, Paju-si (KR)

(73) Assignee: LG Display Co., Ltd., Seoul (KR)

(21) Appl. No.: 19/443,478

(22) Filed: Jan. 8, 2026

(30) Foreign Application Priority Data
May 14, 2025 (KR) 10-2025-0062519

(51) Int. Cl. G09G 3/20; G09G 3/3233; G09G 3/3275; G09G 3/36

(52) U.S. Cl. CPC G09G 3/2074; G09G 3/3233; G09G 3/3275; G09G 3/3607; G09G 3/3688; G09G 3/3696; G09G 2320/02

(57) ABSTRACT

The present disclosure provides a display device including a display panel in which a plurality of subpixels are disposed and on which images representing a plurality of gray levels can be presented, a data driving circuit configured to supply data voltages to the display panel, and a gamma voltage generation circuit configured to supply a plurality of gamma voltages for generating the data voltages supplied to the data driving circuit. The gamma voltage generation circuit supplies the plurality of gamma voltages to the data driving circuit, and differences between voltage values of the plurality of gamma voltages have a linear relationship with respective gray levels corresponding to the plurality of gamma voltages.

### CROSS-REFERENCE TO RELATED APPLICATION

This application claims priority from Korean Patent Application No. 10-2025-0062519, filed on May 14, 2025, in the Korean Intellectual Property Office, which is hereby incorporated by reference for all purposes as if fully set forth herein.

### BACKGROUND

### Technical Field

The present disclosure relates to electronic devices with displays, and more specifically, to display devices.

### Description of the Related Art

In today's information society, display devices for presenting images or visual information to users are increasingly important. The various needs for display devices has caused display technology to be rapidly developed, and indeed, various types of display devices, such as a liquid crystal display (LCD) device, an organic light emitting display (OLED) device, an inorganic light emitting display (iLED) device, a micro light emitting display (micro LED) device, a mini light emitting displays (mini LED) device, a quantum dot light emitting display (QLED) device, and the like, have been developed and widely used.

Display devices may include a display panel in which a plurality of gate lines, a plurality of data lines, and a plurality of subpixels are disposed, a gate driving circuit for driving the plurality of gate lines, a data driving circuit for driving the plurality of data lines, and a controller for controlling the operation of the gate driving circuit and the data driving circuit.

The display devices can supply data voltages to subpixels through data lines at respective times at which each scan signal is applied through gate lines, and thereby, present images representing gray levels corresponding the data voltages by emission of the subpixels.

For example, a data driving circuit for supplying a corresponding data voltage to each subpixel may include a plurality of source driving circuit integrated circuits. In this implementation, each source driving circuit integrated circuit can receive a gamma reference voltage and output a data voltage to be supplied to each subpixel based on the received gamma reference voltage.

### BRIEF SUMMARY

The present disclosure relates to a gamma voltage generation circuit that produces gamma voltage differences that vary linearly with gray level, rather than providing uniformly spaced gamma voltages. This behavior is achieved by using a resistor string disposed between two reference voltages in which the resistors have non uniform resistance values with a constant incremental difference between adjacent resistors. As a result, the spacing between successive gamma voltages increases or decreases in a controlled linear manner across the gray scale, which differs from conventional cascading gamma circuits and linear gamma circuits that rely on uniform resistor values.

One of the technical benefits of the present disclosure is the redistribution of voltage resolution toward perceptually sensitive gray level regions, particularly low gray levels, without increasing the total number of gamma taps, the reference voltage range, or the overall circuit complexity. The total voltage range remains unchanged, while finer voltage steps are provided where luminance accuracy is most critical. This approach improves low gray level luminance control, reduces gray inversion and clumping phenomena, and improves interpolation performance in the data driving circuit, while also enabling a simpler and more compact gamma voltage generation circuit.

The present disclosure further relates to configurations in which the direction of the linear relationship between gamma voltage differences and gray levels can be adjusted by changing the order of resistance values in the resistor string. In this manner, gamma voltage differences may either increase or decrease with gray level using the same circuit structure. This flexibility allows the gamma voltage generation circuit to be adapted to different display characteristics and luminance response requirements, and the described techniques are applicable to a wide range of display devices including liquid crystal displays and self emissive display technologies.

One or more aspects of the present disclosure may provide a display device that includes a resistor string including a plurality of resistors each having a respective resistance value.

One or more aspects of the present disclosure may provide a gamma voltage generation circuit configured to output a plurality of gamma reference voltages such that difference values between voltage values of the plurality of gamma reference voltages have a linear relationship with respective gray levels corresponding to the plurality of gamma reference voltages.

Aspects, examples, and embodiments provided in the present disclosure are not limited to the foregoing description, and additional aspects, examples, and embodiments provided in the present disclosure will become apparent to those skilled in the art from the following description.

According to one or more example embodiments of the present disclosure, a display device can be provided that includes a display panel in which a plurality of subpixels are disposed and on which images representing a plurality of gray levels can be presented, a data driving circuit configured to supply data voltages to the display panel, and a gamma voltage generation circuit configured to supply a plurality of gamma voltages needed to generate data voltages to the data driving circuit. In one or more aspects, the gamma voltage generation circuit can supply the plurality of gamma voltages to the data driving circuit. In one or more aspects, difference values between voltage values of the plurality of gamma voltages may have a linear relationship with respective gray levels corresponding to the plurality of gamma voltages.

According to one or more example embodiments of the present disclosure, a display device can be provided that includes a display panel in which a plurality of subpixels are disposed and on which images representing a plurality of gray levels can be presented, a data driving circuit configured to supply data voltages to the display panel, and a gamma voltage generation circuit configured to supply a plurality of gamma voltages needed to generate data voltages to the data driving circuit. In one or more aspects, the gamma voltage generation circuit may include a first node to which a first reference voltage is supplied, a second node to which a second reference voltage different from the first reference voltage is supplied, and a resistor string disposed between the first node and the second node and including a plurality of resistors. In one or more aspects, respective resistance values of the plurality of resistors may be different from each other, and a difference value between a corresponding resistance value of each of the plurality of resistors and a resistance value of a resistor closest to the corresponding resistor may be a first value.

According to one or more aspects of the present disclosure, a display device may be provided that is capable of accurately providing luminance of low gray levels.

According to one or more aspects of the present disclosure, a display device may be provided that is capable of increasing resolution represented by gamma reference voltages allowing luminance of low gray levels to be represented, and thereby is configured with a lightweight gamma voltage generation circuit.

Effects or advantages from aspects, examples, and embodiments described herein are not limited thereto, and additional effects or advantages will become apparent to those skilled in the art from the following description.

### BRIEF DESCRIPTION OF THE SEVERAL VIEWS OF THE DRAWINGS

The accompanying drawings, which are included to provide a further understanding of the disclosure and are incorporated in and constitute a part of the disclosure, illustrate aspects of the disclosure and together with the description serve to explain principles of the disclosure. In the drawings:

FIG. 1 illustrates a system configuration of an example display device according to aspects of the present disclosure;

FIG. 2 illustrates a block diagram of an example cascading gamma voltage generation circuit according to aspects of the present disclosure;

FIG. 3 illustrates an equivalent circuit of an example brightness control circuit according to aspects of the present disclosure;

FIG. 4 illustrates an equivalent circuit of an example gray level control circuit according to aspects of the present disclosure;

FIG. 5 is an example chart showing voltage variance versus gray level in the cascading gamma voltage generation circuit according to aspects of the present disclosure;

FIG. 6 is an example chart showing luminance variance versus digital gamma voltage in the cascading gamma voltage generation circuit according to aspects of the present disclosure;

FIG. 7 illustrates an equivalent circuit of an example linear gamma voltage generation circuit according to aspects of the present disclosure;

FIG. 8 is an example chart showing voltage variance versus gray level in the linear gamma voltage generation circuit according to aspects of the present disclosure;

FIG. 9 is an example chart showing luminance variance versus digital gamma voltages in the linear gamma voltage generation circuit according to aspects of the present disclosure;

FIG. 10 is an example chart showing a plurality of curves representing luminance with respect to gray levels in the display device according to aspects of the present disclosure;

FIG. 11 illustrates an equivalent circuit of an example first linear delta gamma voltage generation circuit according to aspects of the present disclosure;

FIG. 12 illustrates an example simplified equivalent circuit of the first linear delta gamma voltage generation circuit according to aspects of the present disclosure;

FIG. 13 is an example chart showing gamma voltage variance versus gray level in the first linear gamma voltage generation circuit and the first linear delta gamma voltage generation circuit according to aspects of the present disclosure;

FIG. 14 is an example chart showing gamma voltage versus gray level in the first linear gamma voltage generation circuit and the first linear delta gamma voltage generation circuit according to aspects of the present disclosure;

FIG. 15 is an example chart showing integral values resulting from the first linear gamma voltage generation circuit and the first linear delta gamma voltage generation circuit in the chart of FIG. 13 according to aspects of the present disclosure;

FIG. 16 is an example chart showing integral values resulting from the first linear gamma voltage generation circuit and a second linear delta gamma voltage generation circuit in the chart of FIG. 13 according to aspects of the present disclosure;

FIG. 17 illustrates, in an area form, example respective integral values resulting from the first linear gamma voltage generation circuit, the first linear delta gamma voltage generation circuit, and the second linear delta gamma voltage generation circuit according to aspects of the present disclosure;

FIG. 18 is an example chart showing gamma voltage versus gray level in the first linear gamma voltage generation circuit and a third linear delta gamma voltage generation circuit according to aspects of the present disclosure; and

FIG. 19 is an example chart showing gamma voltage variance versus gray level in the first linear gamma voltage generation circuit and the third linear delta gamma voltage generation circuit according to aspects of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Advantages and features of the present disclosure, and implementation methods thereof will be clarified through following example embodiments described with reference to the accompanying drawings. The present disclosure may, however, be embodied in different forms and should not be construed as limited to the example embodiments set forth herein. Rather, these example embodiments are provided so that this disclosure may be sufficiently thorough and complete to assist those skilled in the art to fully understand the scope of the present disclosure. Further, the protected scope of the present disclosure is defined by claims and their equivalents. In the following description, where the detailed description of the relevant known function or configuration may unnecessarily obscure aspects of the present disclosure, a detailed description of such known function or configuration may be omitted. The shapes, sizes, ratios, angles, numbers, and the like, which are illustrated in the drawings to describe various example embodiments of the present disclosure, are merely given by way of example. Therefore, the present disclosure is not limited to the illustrations in the drawings. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Although the terms “first,” “second,” A, B, (a), (b), and the like may be used herein to describe various elements, these elements should not be interpreted to be limited by these terms as they are not used to define a particular order or precedence. These terms are used only to distinguish one element from another. For example, a first element could be termed a second element, and, similarly, a second element could be termed a first element, without departing from the scope of the present disclosure.

When it is mentioned that a first element “is connected or coupled to”, “contacts”, “overlaps with”, or the like a second element, it should be interpreted that, not only can the first element “be directly connected or coupled to”, “directly contact”, or “directly overlap with” the second element, but a third element can also be “interposed” between the first and second elements, or the first and second elements can “be connected or coupled to”, “contact”, “overlap with”, or the like each other via a fourth element. Here, the second element may be included in at least one of two or more elements that “are connected or coupled to”, “contact”, “overlap with”, or the like each other.

To further elaborate, as used herein, the term “connected” is intended to have the broadest possible meaning. Specifically, the phrase “A is connected to B” encompasses both a direct connection—where no intervening components or elements are present—and an indirect connection, where one or more intermediate components or elements exist between A and B. In other words, “A is connected to B” includes both direct physical or electrical coupling and indirect coupling through one or more intervening components. Unless explicitly stated otherwise, these terms do not require direct physical or electrical contact. The terms “coupled” and “in contact” should be interpreted in the same manner.

Where positional relationships are described, for example, where the positional relationship between two parts is described using “on,” “over,” “under,” “above,” “below,” “beside,” “next,” or the like, one or more other parts may be located between the two parts unless a more limiting term, such as “immediate(ly),” “direct(ly),” or “close(ly)” is used. For example, where an element or layer is disposed “on” another element or layer, a third element or layer may be interposed therebetween. Furthermore, the terms “left,” “right,” “top,” “bottom, “downward,” “upward,” “upper,” “lower,” and the like refer to an arbitrary frame of reference.

In addition, when any dimensions, relative sizes and the like. are mentioned, it should be considered that numerical values for an elements or features, or corresponding information (e.g., level, range, and the like) include a tolerance or error range that may be caused by various factors (e.g., process factors, internal or external impact, noise, and the like) even when a relevant description is not specified. Further, the term “may” fully encompasses all the meanings of the term “can”.

In the following description, various example aspects of the present disclosure are described in detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for convenience of description, a scale, dimension, size, and thickness of each of the elements illustrated in the accompanying drawings may be different from an actual scale, dimension, size, and thickness, and thus, aspects of the present disclosure are not limited to a scale, dimension, size, and thickness illustrated in the drawings.

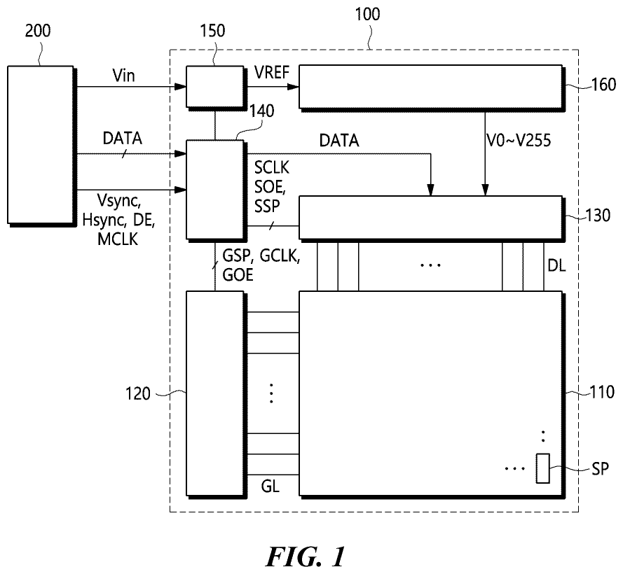

FIG. 1 illustrates a system configuration of an example display device 100 according to aspects of the present disclosure.

Referring to FIG. 1, in one or more example embodiments, the display device 100 may include a display panel 110 in which a plurality of gate lines GL and a plurality of data lines DL are connected or disposed, and a plurality of subpixels SP are arranged in a matrix form, a gate driving circuit 120 configured to drive the plurality of gate lines GL, a data driving circuit 130 configured to supply data voltages through the plurality of data lines DL, a controller 140 configured to control the gate driving circuit 120 and the data driving circuit 130, a power management circuit 160, and a gamma driving circuit 160.

The display panel 110 may be configured to display images based on one or more scan signals transmitted from the gate driving circuit 120 through the plurality of gate lines GL and data voltages transmitted from the data driving circuit 130 through the plurality of data lines DL. Each image presented by the display panel 110 may have at least one gray level (herein, which may be also referred to as gray, grayscale, digital luminance level, luminance intensity, or the like).

In one or more aspects, in an example where the display device 100 is implemented as a liquid crystal display, the display panel 110 may include a liquid crystal layer formed between two substrates, and operate in one or more operating modes, such as a twisted nematic (TN) mode, a vertical alignment (VA) mode, an in-plane switching (IPS) mode, a fringe field switching (FFS) mode, and/or the like. In one or more aspects, in an example where the display device 100 is implemented as a self-emissive display device such as an organic light emitting display or the like, the display panel 110 may be implemented in a top emission structure, a bottom emission structure, or a dual direction emission structure.

The display panel 110 may have a structure where a plurality of pixels are arranged in a matrix form. Each of the plurality of pixels may include subpixels SP configured to emit light of two or more different colors, and for example, include at least two of a white subpixel, a red subpixel, a green subpixel, and/or a blue subpixel. Each of the plurality of pixels may be defined by one or more data lines DL and one or more gate lines GL.

One subpixel SP may include at least one thin film transistor (TFT) formed in an area where a data line DL and at least one gate line GL intersect, a light emitting element, such as an organic light emitting diode or the like, configured to emit light corresponding a data voltage, a storage capacitor electrically connected to the light emitting element and configured to maintain a voltage at a certain level, and the like.

In an example where the display device 100 has the resolution of 2,160×3,840 and each pixel includes four types of subpixels SP including a white subpixel, a red subpixel, a green subpixel, and a blue subpixel, the display device 100 may include 2,160 gate lines GL and 15,360 data lines DL resulting from connecting a respective data line to each of the four types of subpixels SP included in each of 3,840 pixels (i.e., 3,840×4=15,360), and subpixels SP may be respectively disposed in areas defined by the gate lines GL and the data lines DL.

The gate driving circuit 120, which may be controlled by the controller 140, can control driving times for a plurality of subpixels SP by sequentially outputting scan signals to a plurality of gate lines GL disposed in the display panel 110.

In the example where the display device 100 has the resolution of 2,160×3,840, the operation of sequentially outputting scan signals from the first gate line to the 2,160th gate line for 2,160 gate lines GL may be referred to as 2,160-phase driving. Further, as in an example where scan signals are sequentially outputted from the first gate line to the fourth gate line, and then scan signals are sequentially outputted from the fifth gate line to the eighth gate line, the operation of sequentially outputting scan signals on the basis of four gate lines GL may be referred to as 4-phase driving. For example, the operation of sequentially outputting scan signals on the basis of every N number of gate lines GL may be referred to as N-phase driving.

For example, the gate driving circuit 120 may include one or more gate driving integrated circuits GDIC, and be located in two opposing sides or edges of the display panel 110 or only in one side or edge thereof depending on design requirements. In one or more aspects, the gate driving circuit 120 may be implemented in a gate-in-panel (GIP) structure. In this configuration, the gate driving circuit 120 may be disposed in a bezel area of the display panel 110.

The data driving circuit 130 can receive image data DATA from the controller 140, and convert the received image data DATA into data voltages in an analog form. Thereafter, the data driving circuit 130 can output the data voltages to a plurality of data lines DL according to times at which scan signals are applied through gate lines GL. According to these configurations, each subpixel SP connected to a corresponding data line DL can provide light of luminance corresponding to a data voltage. The data drive circuit 130 can generate data voltages based on gamma voltages.

For example, the data driving circuit 130 may include one or more source driving integrated circuits SDIC. In this example, each source driving integrated circuit SDIC may be connected to a bonding pad of the display panel 110 or directly disposed in the display panel 110 in a tape-automated-bonding (TAB) structure or in a chip-on-glass (COG) structure.

In one or more aspects, each source driving integrated circuit SDIC may be disposed to be integrated into the display panel 110. In one or more aspects, each source driving integrated circuit SDIC may be implemented in the display panel 110 by a chip-on-film (COF) technique. In this configuration, each source driving integrated circuit SDIC may be mounted on a circuit film and electrically connected to a data line DL of the display panel 110 through the circuit film.

The controller 140 can supply various control signals to the gate driving circuit 120 and the data driving circuit 130, and control operations of the gate driving circuit 120 and the data driving circuit 130. For example, the controller 140 can cause the gate driving circuit 120 to output scan signals at timings set for scanning corresponding one or more pixels. Further, the controller 140 can receive image data from an external device or system (e.g., a host system 200), and transmit the received image data or data signals corresponding the received image data to the data driving circuit 130.

For example, the controller 140 can receive various timing signals including a vertical synchronization signal Vsync, a horizontal synchronization signal Hsync, a data enable signal DE, a main clock MCLK, and the like, along with image data from the host system 200.

The host system 200 may be any one of a television (TV), a set top box, a navigation system, a personal computer (PC), a home theater system, a mobile device, a wearable device, and the like.

According to these configurations, the controller 140 can generate control signals using various timing signals received from the host system 200, and supply the control signals to the gate driving circuit 120 and the data driving circuit 130.

For example, the controller 140 can supply various gate control signals including a gate start pulse GSP, a gate clock GCLK, a gate output enable signal GOE, and the like to control the gate drive circuit 120. The gate start pulse GSP may be used for controlling an operation start time of one or more gate driver integrated circuits included in the gate drive circuit 120. The gate clock GCLK may be a clock signal commonly input to one or more gate driving integrated circuits GDIC and be used for controlling a shift time of a gate signal (or a gate pulse). The gate output enable signal GOE may be used for indicating time information of one or more gate driving integrated circuits GDIC.

For example, the controller 140 can supply various data control signals including a source start pulse SSP, a source sampling clock SCLK, a source output enable signal SOE, and the like to control the data driving circuit 130. The source start pulse SSP may be used for controlling a data sampling start time of one or more source driver integrated circuits SDIC included in the data driving circuit 130. The source sampling clock SSC may be a clock signal for controlling a sampling time of data in one or more source driver integrated circuits SDIC. The source output enable signal SOE may be used for controlling an output time of the data driving circuit 130.

The display device 100 may include a power management circuit 150 configured to supply various voltages or currents to the display panel 110, the gate driving circuit 120, the data driving circuit 130, and the like, or control various voltages or currents to be supplied thereto.

The power management circuit 150 can adjust a DC input voltage Vin supplied by the host system 200 and generate voltages or currents needed for driving the display panel 110, the gate driving circuit 120, and the data driving circuit 130.

Meanwhile, each subpixel SP may be located at a corresponding location at which at least one corresponding gate line GL and a corresponding data line DL intersect each other, and a corresponding light emitting element such an organic light emitting diode may be disposed in each subpixel SP. In an example where the display device 100 is implemented as an organic light emitting display device including organic light emitting elements such as organic light emitting diodes or the like, the display device 100 may include light emitting elements disposed in subpixels SP, and can display images by controlling current flowing to the light emitting elements according to data voltages.

In one or more aspects, the display device 100 may be various types of devices such as a liquid crystal display (LCD), an organic light emitting display (OLED), an inorganic light emitting display, a micro light emitting display, a mini light emitting display, a quantum dot (QD) light emitting display, a plasma display panel (PDP). and the like.

The gamma driving circuit 160 can supply a plurality of gamma voltages (V0 to V255) to the data driving circuit 130 to generate data voltages. For example, the gamma driving circuit 160 can supply a first gamma voltage VGMA1 or a second gamma voltage VGMA2 to the data driving circuit 130.

The gamma driving circuit 160 may include a gamma voltage generation circuit for a red subpixel, a gamma voltage generation circuit for a green subpixel, and a gamma voltage generation circuit for a blue subpixel.

For example, the gamma driving circuit 160 may include respective gamma voltage generation circuits for controlling red subpixels, blue subpixels, and green subpixels.

The gamma driving circuit 160 may include at least one gamma voltage generation circuit for all red subpixels, blue subpixels, and green subpixels.

For example, the gamma driving circuit 160 may include a gamma voltage generation circuit capable of controlling red subpixels, blue subpixels, and green subpixels together or simultaneously.

In one or more aspects, the gamma voltage generation circuit may be one of a cascading gamma voltage generation circuit, a linear gamma voltage generation circuit, or a linear delta gamma voltage generation circuit.

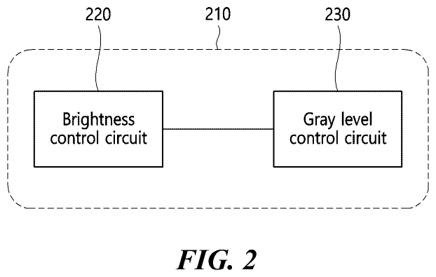

Detailed descriptions of the cascading gamma voltage generation circuit, the linear gamma voltage generation circuit, and the linear delta gamma voltage generation circuit are provided below with reference to FIG. 2 and figures following FIG. 2.

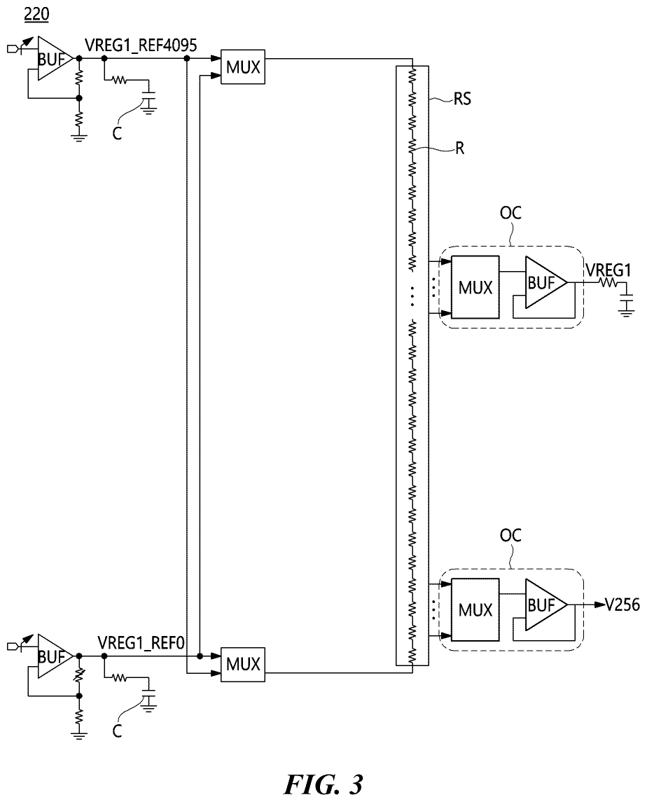

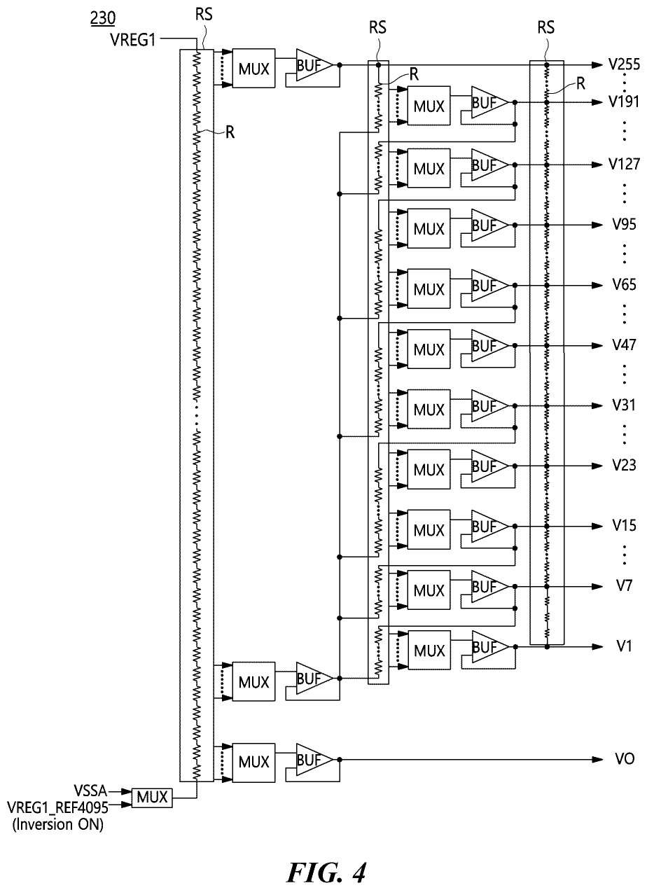

FIG. 2 illustrates a block diagram of an example cascading gamma voltage generation circuit 210 according to aspects of the present disclosure. FIG. 3 illustrates an equivalent circuit of an example brightness control circuit 220 according to aspects of the present disclosure. FIG. 4 illustrates an equivalent circuit of an example gray level control circuit 230 according to aspects of the present disclosure.

Referring to FIG. 2, the cascading gamma voltage generation circuit 210 may include the brightness control circuit 220 and the gray level control circuit 230.

The brightness control circuit 220 and the gray level control circuit 230 may be electrically connected.

Referring to FIG. 3, the brightness control circuit 220 can supply a first reference voltage VREG1 to the gray level control circuit 230.

Referring to FIG. 3, the brightness control circuit 220 may include a plurality of output buffers BUF, a plurality of selection circuits MUX, a resistor string RS (also referred to as a resistance string RS) including a plurality of resistors R, and a plurality of stabilizing capacitors C electrically connected to the plurality of buffers BUF.

Hereinafter, the cascading gamma voltage generation circuit 210 for controlling one or more green subpixels is described.

However, it should be noted that the description of the cascading gamma voltage generation circuit 210 for the one or more green subpixels is merely for convenience of description, and the description for the green subpixels can be also equally applied to respective cascading gamma voltage generation circuits 210 for one or more green subpixels and one or more green blue subpixels is excluded.

For example, respective cascading gamma voltage generation circuits 210 for controlling one or more red subpixels and one or more blue subpixels can have the same structure as the cascading gamma voltage generation circuit 210 of FIGS. 2 to 4.

An output buffer BUF at an upper portion (or an upper terminal) of the brightness control circuit 220 can output an upper reference voltage VREG1_REF4095 to a selection circuit MUX at a lower portion (or a lower terminal), or a selection circuit MUX at the upper portion (or the upper terminal), of the brightness control circuit 220.

An output buffer BUF at the lower portion (or the lower terminal) of the brightness control circuit 220 can output a lower reference voltage VREG1_REF0 to the selection circuit MUX at the upper portion (or the upper terminal), or the selection circuit MUX at the lower portion (or the lower terminal), of the brightness control circuit 220.

Each of the selection circuit MUX at the upper portion (or the upper terminal) and the selection circuit MUX at the lower portion (or the lower terminal) can select one of the upper reference voltage VREG1_REF4095 or the lower reference voltage VREG1_REF0 and output the selected one to the resistor string RS. In this implementation, the upper selection circuit MUX and the lower selection circuit MUX may not output an identical voltage.

For example, when the upper reference voltage VREG1_REF4095 is input to a lower portion (or a lower terminal) of the resistor string RS and the lower reference voltage VREG1_REF0 is input to an upper portion (or an upper terminal) of the resistor string RS, this may be referred to as gamma inversion.

The resistor string RS can distribute the input upper reference voltage VREG1_REF4095 and the input lower reference voltage VREG1_REF0 through a plurality of resistors R.

An output circuit OC connected to an output terminal of the resistor string RS can output a first reference voltage VREG1. The first reference voltage VREG1 can be supplied to the gray level control circuit 230.

Another output circuit OC connected to the output terminal of the resistor string RS can output a 256th gamma voltage V256.

Each output circuit OC may include a selection circuit MUX and an output buffer BUF.

Referring to FIG. 4, the gray level control circuit 230 may include a plurality of output buffers BUF, a plurality of selection circuits MUX, and a plurality of resistor strings RS each including a plurality of resistors R.

The first reference voltage VREG1 may be input to an upper portion (or an upper terminal) of the gray level control circuit 230. The first reference voltage VREG1 may be supplied to an upper portion (or an upper terminal) of a resistor string RS.

A driving voltage VSSA or the upper reference voltage VREG1_REF4095 may be input to a selection circuit MUX at a lower portion (or a lower terminal) of the gray level control circuit 230.

The selection circuit MUX can select one of the driving voltage VSSA or the upper reference voltage VREG1_REF4095 and output the selected one to a lower portion (or a lower terminal) of the resistor string RS.

For example, when gamma inversion is performed, the selection circuit MUX can output the upper reference voltage VREG1_REF4095 to the resistor string RS.

For example, when gamma inversion is not performed, the selection circuit MUX can output the driving voltage VSSA to the resistor string RS. The driving voltage VSSA may be a low voltage.

The gray level control circuit 230 may have a structure where a plurality of resistor strings RS, a plurality of selection circuits MUX, and a plurality of output buffers BUF are consecutively arranged in a cascading manner.

Accordingly, the gray level control circuit 230 can distribute voltages. The gray level control circuit 230 may output the distributed voltages as a plurality of gamma voltages (V0 to V255).

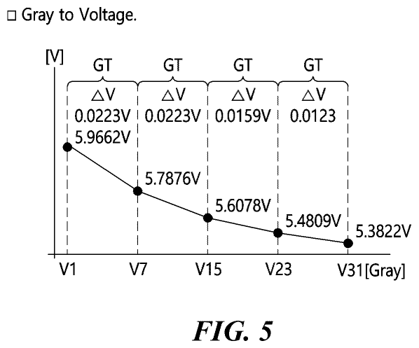

FIG. 5 is an example chart showing voltage variance versus gray level in the cascading gamma voltage generation circuit 210 according to aspects of the present disclosure.

Referring to FIG. 5, intervals between respective values of the plurality of gamma voltages (V0 to V255) may be referred to as gamma taps GT.

In an example where the cascading gamma voltage generation circuit 210 is used among several types of gamma voltage generation circuits, the data driving circuit 130 can interpolate voltages between the gamma taps GT.

In the example where the cascading gamma voltage generation circuit 210 is used as a gamma voltage generation circuit, voltage values may vary significantly at points where the gamma taps GT change.

In this case, the interpolation performance of the data drive circuit 130 may be degraded.

Hereinafter, discussions are provided for luminance changes due to the degradation of interpolation performance.

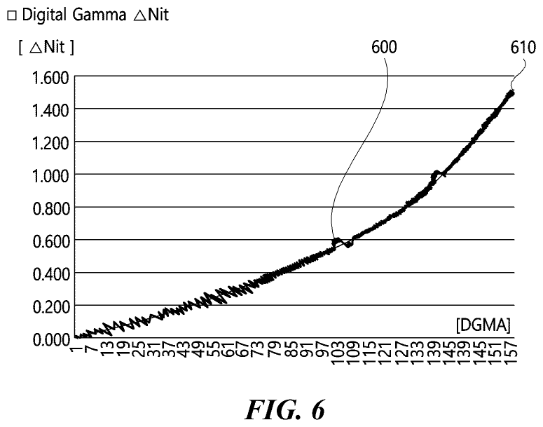

FIG. 6 is an example chart showing luminance variance versus digital gamma voltage DGMA in the cascading gamma voltage generation circuit 210 according to aspects of the present disclosure.

Referring to FIG. 6, the horizontal axis of the chart may represent digital gamma voltages DGMA. The vertical axis of the chart may represent luminance variances.

A curve 600 representing actual luminance variances of images corresponding to digital gamma voltages DGMA may be different from a curve 610 representing ideal luminance variances. The unit of the luminance variance may be Nit.

When luminance variances in the curve 610 representing ideal luminance variances and actual luminance variances of images corresponding to digital gamma voltages DGMA are different from each other, the quality of images may be degraded.

Hereinafter, discussions are provided for an example linear gamma voltage generation circuit.

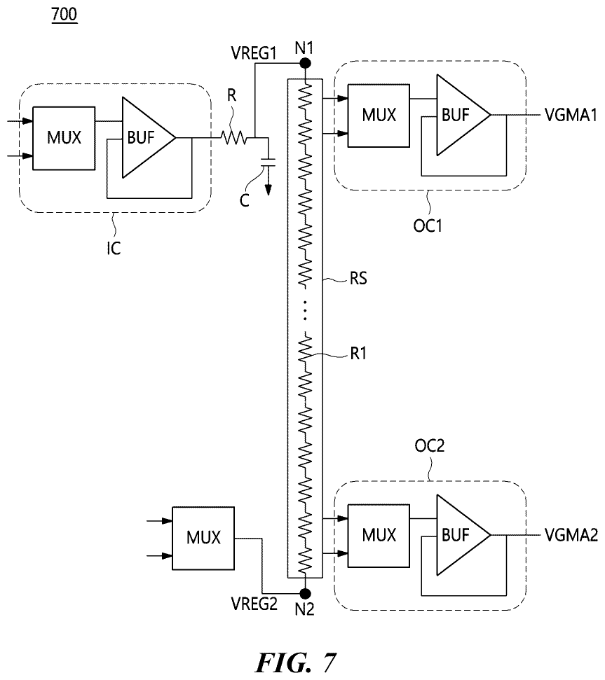

FIG. 7 illustrates an equivalent circuit of an example linear gamma voltage generation circuit 700 according to aspects of the present disclosure.

Referring to FIG. 7, the linear gamma voltage generation circuit 700 may include an input circuit IC, a first output circuit OC1, a second output circuit OC2, a resistor string RS including a plurality of first resistors R1, a resistor R electrically connected to the input circuit IC, a stabilizing capacitor C electrically connected to the resistor R, and a selection circuit MUX electrically connected to a lower portion (or a lower terminal) of the resistor string RS.

The input circuit IC may include a selection circuit MUX and an output buffer BUF. This selection circuit MUX can supply one of a plurality of input signals (or a plurality of voltages) to the output buffer BUF. The output buffer BUF can stabilize the received signal and output the stabilized signal.

For example, the input circuit IC can supply a first reference voltage VREG1 to the resistor string RS. The input circuit IC can supply the first reference voltage VREG1 to a first node N1. For example, the first reference voltage VREG1 may be a high voltage.

The resistor R may be connected between the input circuit IC and the first node N1. The resistor R between the input circuit IC and the first node N1 may be electrically connected to the stabilizing capacitor C.

For example, the selection circuit MUX at a lower portion (or a lower terminal) of the linear gamma voltage generation circuit 700 can supply a second reference voltage VREG2 to the resistor string RS. The selection circuit MUX at the lower portion of the linear gamma voltage generation circuit 700 can supply a second reference voltage VREG2 to a second node N2. For example, the second reference voltage VREG2 may have a different voltage value than the first reference voltage VREG1. For example, the second reference voltage VREG2 may be a low voltage.

The resistor string RS can distribute a plurality of voltages between the first reference voltage VREG1 and the second reference voltage VREG2 through a plurality of first resistors R1.

For example, the plurality of first resistors R1 may have the same resistance value. It should be understood here that the same resistance value can include resistance values within a similar range.

The first output circuit OC1 may include a selection circuit MUX and an output buffer BUF. For example, the first output circuit OC1 may output a first gamma voltage VGMA1. For example, the first gamma voltage VGMA1 may be one of a plurality of gamma voltages (V0 to V255). For example, the first gamma voltage VGMA1 may be a gamma voltage corresponding to a white gray level.

The second output circuit OC2 may include a selection circuit MUX and an output buffer BUF. For example, the second output circuit OC2 can output a second gamma voltage VGMA2. For example, the second gamma voltage VGMA2 can be one of the gamma voltages (V0 to V255). For example, the second gamma voltage VGMA2 can be a gamma voltage corresponding to a black gray level.

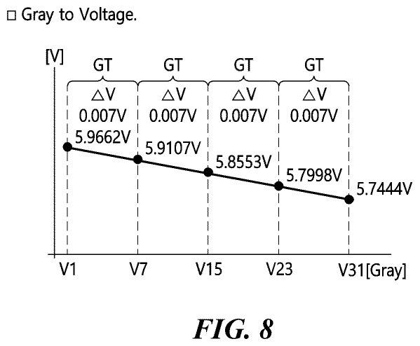

FIG. 8 is an example chart showing voltage variance versus gray level in the linear gamma voltage generation circuit 700 according to aspects of the present disclosure.

Referring to FIG. 8, intervals between respective values of the gamma voltages (V0 to V255) may be referred to as gamma taps GT as described above with reference to FIG. 5.

In an example where the linear gamma voltage generation circuit 700 is used in the display device 100, the data driving circuit 130 can interpolate voltages between the gamma taps GT.

In the example where the linear gamma voltage generation circuit 700 is used in the display device 100, voltage values may not vary significantly at points where the gamma taps GT change.

In this case, the interpolation performance of the data driving circuit 130 may not be degraded.

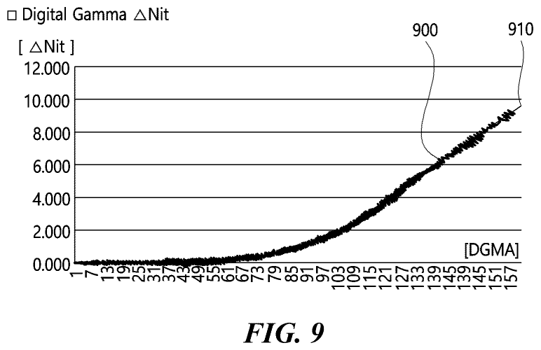

FIG. 9 is an example chart showing luminance variance versus digital gamma voltage DGMA in the linear gamma voltage generation circuit 700 according to aspects of the present disclosure.

Referring to FIG. 9, a curve 900 representing actual luminance variances of images corresponding to digital gamma voltages DGMA may be different from a curve 910 representing ideal luminance variances. The unit of the luminance variance may be Nit.

When luminance variances in the curve 910 representing ideal luminance variances and actual luminance variances of images corresponding to digital gamma voltages DGMA are different from each other, the quality of images may be degraded.

Comparing the chart of FIG. 9 with that of FIG. 6, when the linear gamma voltage generation circuit 700 is used as a gamma voltage generation circuit, a difference between luminance variances in the curve (610, 910) representing ideal luminance variances and actual luminance variances (600, 900) of images corresponding to digital gamma voltages DGMA may become small.

Therefore, when the linear gamma voltage generation circuit 700 is used in the display device 100 as a gamma voltage generation circuit, the degradation of image quality can be minimized or reduced.

Further, since the linear gamma voltage generation circuit 700 may include fewer components than the cascading gamma voltage generation circuit 210, the linear gamma voltage generation circuit 700 can provide an advantage of being thinner or lighter.

As the gamma voltage generation circuit becomes lighter or thinner, production costs and materials can be reduced.

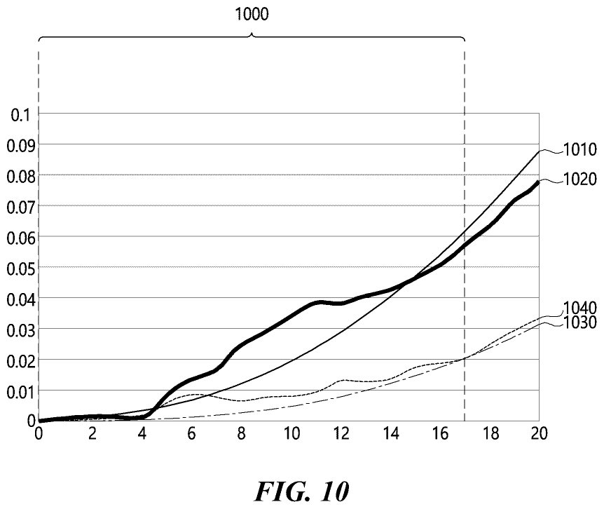

FIG. 10 is an example chart showing a plurality of curves representing luminance with respect to gray levels in the display device according to aspects of the present disclosure.

Referring to FIG. 10, the chart may be a chart representing luminance with respect to gray levels when the linear gamma voltage generation circuit 700 is used in the display device 100 as a gamma voltage generation circuit.

The horizontal axis of the chart may represent gray levels, and the vertical axis of the chart may represent luminance.

The chart may include a first reference curve 1010, a first measurement curve 1020, a second reference curve 1030, and a second measurement curve 1040.

For example, the first reference curve 1010 and the second reference curve 1030 may be curves representing luminance values according to respective gray levels targeted by different display devices 100. For example, the first reference curve 1010 may be referred to as gamma 2.2. For example, the second reference curve 1030 may be referred to as gamma 2.4.

For example, the first measurement curve 1020 may be a curve obtained by actually measuring luminance with respect to gray levels in a display device 100, which aims to represent luminance according to the first reference curve 1010.

For example, the second measurement curve 1040 may be a curve obtained by actually measuring luminance with respect to gray levels in a display device 100, which aims to represent luminance according to the second reference curve 1030.

Referring to the first reference curve 1010 and the first measurement curve 1020, in a low gray level range 1000, a gray level inversion phenomenon may occur in which luminance values of the first measurement curve 1020 become greater than luminance values of the first reference curve 1010.

Further, referring to the second reference curve 1030 and the second measurement curve 1040, in the low gray level range 1000, a gray level inversion phenomenon may occur in which luminance values of the second measurement curve 1040 become greater than luminance values of the second reference curve 1020.

Further, referring to the first measurement curve 1020 and the second measurement curve 1040, a gray level clumping phenomenon may occur in which luminance changes corresponding to gray levels do not occur or luminance according to the gray levels decreases.

These phenomena may increase as a luminance driving range of the display device 100 increases.

Further, a user of the display device 100 may be more sensitive to luminance changes in the low gray level range (or the low luminance range). To address these issues, it may be desired that the display device 100 increases the resolution of gamma voltages in the low gray level range.

Hereinafter, to increase the resolution of gamma voltages in the low gray level range, discussions are provided for an example linear delta gamma voltage generation circuit (e.g., a first delta linear gamma voltage generation circuit, a second delta linear gamma voltage generation circuit, and/or a third delta linear gamma voltage generation circuit).

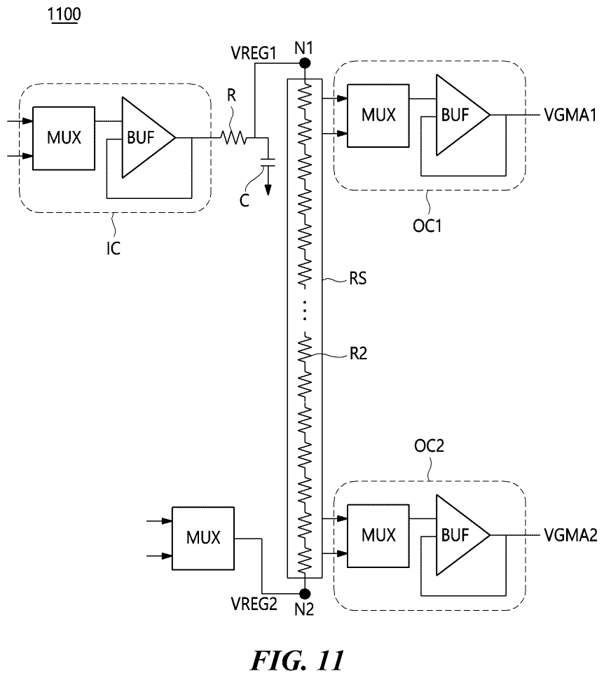

FIG. 11 illustrates an equivalent circuit of an example first linear delta gamma voltage generation circuit 1100 according to aspects of the present disclosure.

Referring to FIG. 11, the first linear delta gamma voltage generation circuit 1100 may have the same structure as the linear gamma voltage generation circuit 700 discussed above.

In discussions that follow for the configuration of FIG. 11, features equal, substantially equal, or similar to the features of the linear gamma voltage generation circuit 700 may not be repeatedly described for convenience of description.

The first linear delta gamma voltage generation circuit 1100 may include an input circuit IC, a first output circuit OC1, a second output circuit OC2, a resistor string RS including a plurality of second resistors R2, a resistor R electrically connected to the input circuit IC, a stabilizing capacitor C electrically connected to the resistor R, and a selection circuit MUX electrically connected to a lower portion (or a lower terminal) of the resistor string RS.

The plurality of second resistors R2 may be referred to as the plurality of resistors.

For example, the plurality of second resistors R2 may have different resistance values.

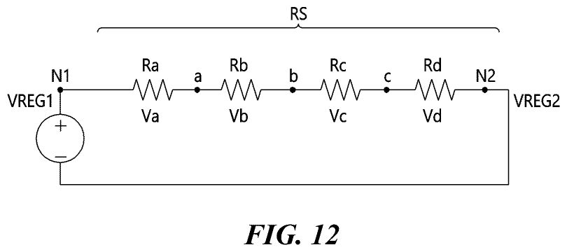

A detailed description thereof is provided with reference to FIG. 12.

FIG. 12 illustrates an example simplified equivalent circuit of the first linear delta gamma voltage generation circuit 1100 according to aspects of the present disclosure.

FIG. 12 illustrates an example where the resistor string RS includes four resistors R. However, it should be noted that the example of the four resistors R is merely for convenience of explanation. Therefore, the number of resistors R included in the first linear delta gamma voltage generation circuit 1100 is not limited thereto.

Referring to FIG. 12, the first linear delta gamma voltage generation circuit 1100 may include four resistors (Ra, Rb, Rc, and Rd).

The first linear delta gamma voltage generation circuit 1100 may include a first node N1, node a, node b, node c, and a second node N2.

A first reference voltage VREG1 may be supplied to the first node N1 of the first linear delta gamma voltage generation circuit 1100.

A second reference voltage VREG2 may be supplied to the second node N2 of the first linear delta gamma voltage generation circuit 1100.

Resistance values of the four resistors (Ra, Rb, Rc, and Rd) may be different from each other. Accordingly, respective voltage values (or voltage levels or voltage states) of the first node N1, node a, node b, node c, and the second node N2 may be different from each other.

The gamma voltages (V0 to V255) may be output depending on the voltage values of the first node N1, node a, node b, node c, and the second node N2.

For example, among respective resistance values of the resistors (Ra, Rb, Rc, and Rd) included in the first linear delta gamma voltage generation circuit 1100, the resistance value of a resistor (e.g., Ra) closest to the first node N1 may be the smallest.

For example, among respective resistance values of the resistors (Ra, Rb, Rc, and Rd) included in the first linear delta gamma voltage generation circuit 1100, the resistance value of a resistor (e.g., Rd) closest to the second node N2 may be the greatest.

For example, respective voltage values across the resistors (Ra, Rb, Rc, and Rd) may be calculated using the following mathematical equations.

Vₐ=r

(V_{b}+Vₐ)−Vₐ=r+a

(V_{c}+V_{b}+Vₐ)−(Vₐ+V_{b})=r+2a

(Vₐ+V_{c}+V_{b}+Vₐ)−(V_{c}+V_{b}+Vₐ)=r+3a

For example, respective voltage values across the resistors (Ra, Rb, Rc, and Rd) may be as follows.
a. Voltage Va across the resistor Ra may have a value of r.
b. Voltage Vb across the resistor Rb may have a value of r+a.
c. Voltage Vc across the resistor Rc may have a value of r+2a.
d. Voltage Vd across the resistor Rd may have a value of r+3a.

In other words, a voltage drop Va across the resistor Ra closest to the first node N1 may be smaller than voltage drops (Vb, Vc, and Vd) across the remaining resistors (Rb, Rc, and Rd) except for the resistor Ra closest to the first node N1.

Further, a voltage drop Vd across the resistor Rd closest to the second node N2 may be greater than voltage drops (Va, Vb, and Vc) across the remaining resistors (Ra, Rb, and Rc) except for the resistor Rd closest to the second node N2.

Thus, as the voltage drop increases, gamma voltage variances may increase.

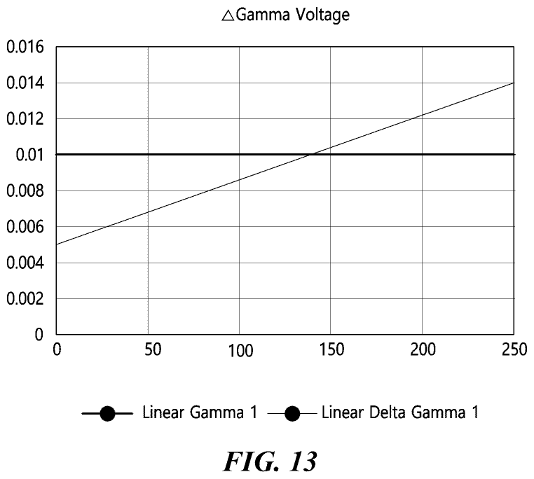

Accordingly, difference values between the gamma voltages (V0~V255) may have a linear relationship with respective gray levels corresponding to the gamma voltages (V0~V255). A detailed description on this is provided below with reference to FIG. 13.

The r value can be calculated using the following mathematical equation.

$${V}_{a} = r = {KR}_{a} \qquad \frac{VREG 1 - VREG 2}{{R}_{a} + {R}_{b} + {R}_{c} + {R}_{d}} = K$$

For example, respective resistance values of the resistors (Ra, Rb, Rc, and Rd) can be calculated using the following mathematical equation.

$$∴ {R}_{a} = \frac{r}{K} ∴ {R}_{b} = \frac{r + a}{K} ∴ {R}_{c} = \frac{r + 2 a}{K} ∴ {R}_{d} = \frac{r + 3 a}{K}$$

A difference value between a corresponding resistance value of each of the resistors (Ra, Rb, Rc, and Rd) and a resistance value of a resistor closest to the corresponding resistor may be a first value. The first value may be a divided by K.

For example, a difference between a corresponding resistance value of each of the plurality of second resistors R2 and a resistance value of a resistor closest to the corresponding resistor may be a first value.

FIG. 13 is an example chart showing gamma voltage variance versus gray level in a first linear gamma voltage generation circuit and the first linear delta gamma voltage generation circuit 1100 according to aspects of the present disclosure.

Referring to FIG. 13, the horizontal axis of the chart may represent gray levels, and the vertical axis of the chart may represent gamma voltage variances.

Hereinafter, the first linear gamma voltage generation circuit may be the same circuit as the linear gamma voltage generation circuit 700 in FIG. 7.

For example, since a plurality of first resistors R1 included in a resistor string RS of the first linear gamma voltage generation circuit all have the same resistance value, respective variances of the gamma voltages (V0 to V255) corresponding to gray levels may be constant.

For example, the second resistors R2 included in the resistor string RS of the first linear delta gamma voltage generation circuit 1100 may have different resistance values. The second resistors R2 included in the resistor string RS of the first linear delta gamma voltage generation circuit 1100, which are disposed in a sequential order from a location closest to the first node N1 to a location closest to the second node N2 to the second resistor R2, may have resistance values of gradually increasing by the first value.

Accordingly, respective variances of the gamma voltages (V0 to V255) corresponding to gray levels of the first linear delta gamma voltage generation circuit 1100 (or difference values between the gamma voltages) may have a linear relationship with the gray levels.

It should be understood here that the linear relationship may include a linear relationship within a similar range.

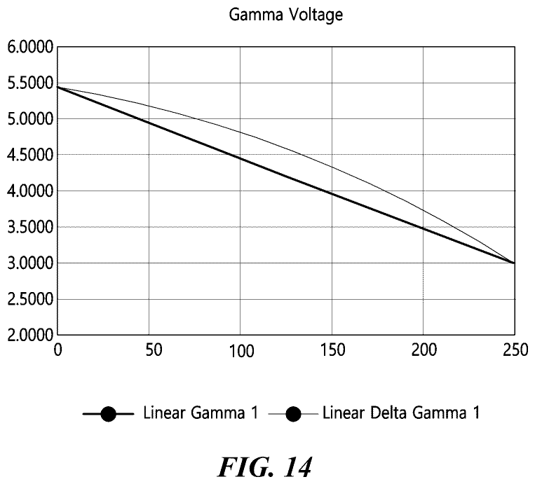

FIG. 14 is an example chart showing gamma voltage versus gray level in the first linear gamma voltage generation circuit and the first linear delta gamma voltage generation circuit 1100 according to aspects of the present disclosure.

Referring to FIG. 14, the horizontal axis of the chart may represent gray levels, and the vertical axis of the chart may represent gamma voltages.

As described above, since respective variances of the gamma voltages (V0 to V255) of the first linear gamma voltage generation circuit are constant, the gamma voltages (V0 to V255) may have a linear relationship with the gray levels.

As described above, since respective variances of the gamma voltages (V0 to V255) of the first linear delta gamma voltage generation circuit 1100 gradually increase, the absolute value of the slope of a curve representing the gamma voltages may be small in a low gray level range and be great in a high gray level range.

Since the absolute value of the slope of the voltage curve is small in the low gray level range, the first linear delta gamma voltage generation circuit 1100 can provide an increased resolution between gamma voltages.

Accordingly, in an example where the first linear delta gamma voltage generation circuit 1100 is used in the display device 100 as a gamma voltage generation circuit, luminance variances in a highly sensitive low gray level range can be finely adjusted.

Further, even when the resolution of gamma voltages in a high gray level range is reduced, sensitivity (or perception ability) of users is relatively low in the high gray level range, and therefore, undesired luminance changes in the display device 100 may not be detected.

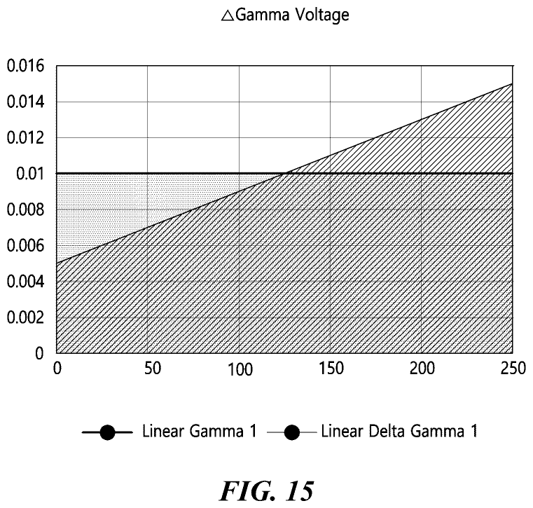

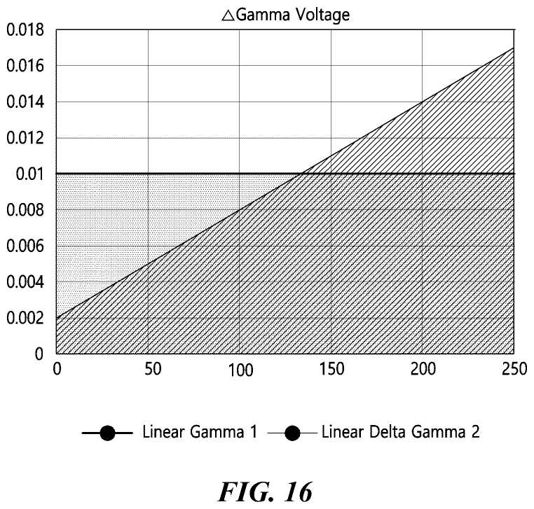

FIG. 15 is an example chart showing integral values resulting from the first linear gamma voltage generation circuit and the first linear delta gamma voltage generation circuit 1100 in the chart of FIG. 13 according to aspects of the present disclosure. FIG. 16 is an example chart showing integral values resulting from the first linear gamma voltage generation circuit and a second linear delta gamma voltage generation circuit in the chart of FIG. 13 according to aspects of the present disclosure.

Referring to FIGS. 15 and 16, the horizontal axis of the chart may represent gray levels, and the vertical axis of the chart may represent gamma voltage variances.

The second linear delta gamma voltage generation circuit may have the same structure as the first linear delta gamma voltage generation circuit 1100.

Variances between the gamma voltages (V0 to V256) of the second linear delta gamma voltage generation circuit may be greater than variances between the gamma voltages (V0 to V256) of the first linear delta gamma voltage generation circuit 1100.

In other words, resistance value differences between a plurality of resistors included in a resistor string RS of the second linear delta gamma voltage generation circuit may be greater than resistance value differences between the plurality of resistors included in the resistor string RS of the first linear delta gamma voltage generation circuit 1100.

Accordingly, a curve representing the gamma voltage variances in the second linear delta gamma voltage generation circuit may have a greater slope.

For example, when gamma voltage variances in a particular range are small, voltage resolution in that range may become good.

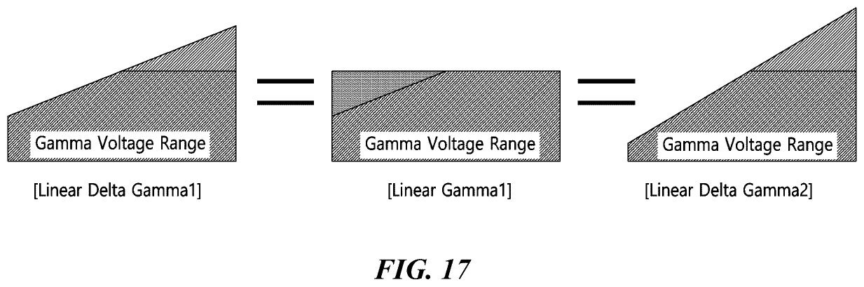

FIG. 17 illustrates, in an area form, example respective integral values resulting from the first linear gamma voltage generation circuit, the first linear delta gamma voltage generation circuit, and the second linear delta gamma voltage generation circuit according to aspects of the present disclosure.

Referring to FIG. 17, the integral values of the first linear gamma voltage generation circuit, the second linear gamma voltage generation circuit, and the first linear delta gamma voltage generation circuit may be the same.

The same integral values of the integral values of the first linear gamma voltage generation circuit, the first linear delta gamma voltage generation circuit, and the second linear delta gamma voltage generation circuit may mean that the voltage ranges of the gamma voltages (V0 to V256) are the same and the range of representable luminance is the same.

Therefore, when the display device 100 uses the first linear delta gamma voltage generation circuit 1100 as a gamma voltage generation circuit, the display device 100 may further allocate voltage resolution to a low gray level range.

Hereinafter, discussions are provided examples where variances between the gamma voltages (V0 to V255) are needed to gradually decrease depending on types of the display device 100.

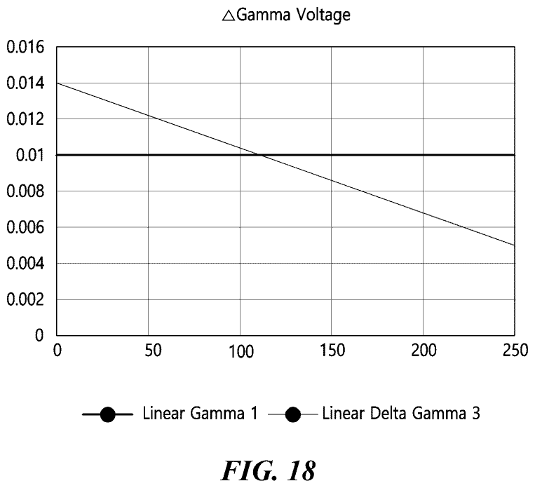

FIG. 18 is an example chart showing gamma voltage versus gray level in the first linear gamma voltage generation circuit and a third linear delta gamma voltage generation circuit according to aspects of the present disclosure.

Referring to FIG. 18, the horizontal axis of the chart may represent gray levels, and the vertical axis may represent gamma voltage variances.

A curve representing gamma voltage variances in the first linear gamma voltage generation circuit may be the same as the curve representing gamma voltage variances in the first linear gamma voltage generation circuit in FIG. 13.

The third linear delta gamma voltage generation circuit may be a circuit having a structure in which variances between the gamma voltages (V0 to V255) gradually decreases.

For example, the third linear delta gamma voltage generation circuit may have the same structure as the first linear gamma voltage generation circuit and the first linear delta gamma voltage generation circuit.

For example, respective values of a plurality of resistors R in a resistor string RS of the third linear delta gamma voltage generation circuit may be different from each other.

For example, a difference value between a corresponding resistance value of each of the plurality of resistors R in the resistor string RS of the third linear delta gamma voltage generation circuit and a resistance value of a resistor R closest to the corresponding resistor may be a first value.

For example, the resistance value of a resistor R closest to a first node N1 among the plurality of resistors R in the resistor string RS of the third linear delta gamma voltage generation circuit may be the greatest among the resistance values of the plurality of resistors R.

For example, the resistance value of a resistor R closest to a second node N2 among the plurality of resistors R in the resistor string RS of the third linear delta gamma voltage generation circuit may be the smallest among the resistance values of the plurality of resistors R.

For example, the second resistors included in the resistor string RS of the third linear delta gamma voltage generation circuit, which are disposed in a sequential order from a location closest to the first node N1 to a location closest to the second node N2 to the second resistor R2, may have resistance values of gradually decreasing by the first value.

Accordingly, respective variances of the gamma voltages (V0 to V255) corresponding to gray levels of the third linear delta gamma voltage generation circuit 1100 (or difference values between the gamma voltages) may have a linear relationship with the gray levels.

It should be noted that unlike the slope of the linear relationship in FIG. 13, the linear relationship in FIG. 18 may have a negative slope.

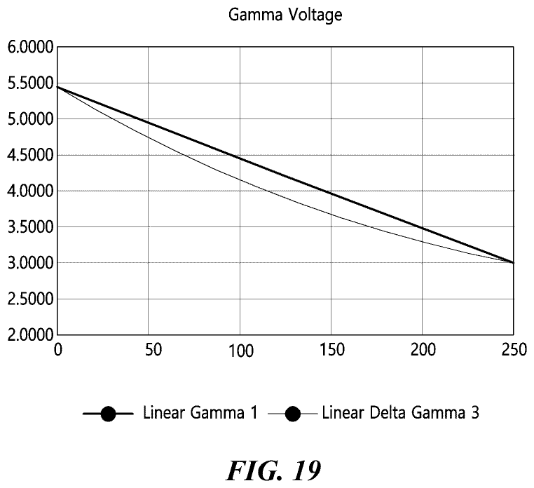

FIG. 19 is an example chart showing gamma voltage versus gray level in the second linear gamma voltage generation circuit and the second linear delta gamma voltage generation circuit according to aspects of the present disclosure.

Referring to FIG. 19, the horizontal axis of the chart may represent gray levels, and the vertical axis of the chart may represent gamma voltages.

A curve representing gamma voltages in the second linear gamma voltage generation circuit may be the same as the curve representing gamma voltages in the first linear gamma voltage generation circuit in FIG. 14.

As described above, since respective variances of the gamma voltages (V0 to V255) of the first linear gamma voltage generation circuit are constant, the gamma voltages (V0 to V255) may have a linear relationship with the gray levels.

As described above, since respective variances of the gamma voltages (V0 to V255) of the third linear delta gamma voltage generation gradually decrease, the absolute value of the slope of a curve representing the gamma voltages may be great in a low gray level range and be small in a high gray level range.

Since the absolute value of the slope of the voltage curve is small in the low gray level range, the third linear delta gamma voltage generation circuit may provide a reduced resolution between the gamma voltages.

Since the absolute value of the slope of the voltage curve is great in the high gray level range, the third linear delta gamma voltage generation circuit can provide an increased resolution between gamma voltages.

The examples, aspects, and embodiments for the display device 100 and the display panel 110 described herein may be described as follows.

According to the one or more example embodiments described herein, a display device can be provided that includes a display panel in which a plurality of subpixels are disposed and on which images representing a plurality of gray levels can be presented, a data driving circuit configured to supply data voltages to the display panel, and a gamma voltage generation circuit configured to supply a plurality of gamma voltages to generate data voltages to the data driving circuit.

In one or more aspects, the gamma voltage generation circuit can supply the plurality of gamma voltages to the data driving circuit.

In one or more aspects, difference values between voltage values of the plurality of gamma voltages may have a linear relationship with respective gray levels corresponding to the plurality of gamma voltages.

In one or more aspects, the gamma voltage generation circuit may include a first node to which a first reference voltage is supplied, a second node to which a second reference voltage is supplied, and a resistor string disposed between the first node and the second node and including a plurality of resistors.

In one or more aspects, respective resistance values of the plurality of resistors may be different from each other. In one or more aspects, a difference value between a corresponding resistance value of each of the plurality of resistors and a resistance value of a resistor closest to the corresponding resistor may be a first value.

In one or more aspects, a resistance value of a first resistor closest to the first node among the plurality of resistors may be the smallest among resistance values of the plurality of resistors.

In one or more aspects, a resistance value of a second resistor closest to the second node among the plurality of resistors may be the greatest among the resistance values of the plurality of resistors.

In one or more aspects, a resistance value of a first resistor closest to the first node among the plurality of resistors may be the greatest among resistance values of the plurality of resistors.

In one or more aspects, a resistance value of a second resistor closest to the second node among the plurality of resistors may be the smallest among the resistance values of the plurality of resistors.

In one or more aspects, the gamma voltage generation circuit may include a first output circuit configured to output a first gamma voltage and electrically connected to the resistor string, and a second output circuit configured to output a second gamma voltage and electrically connected to the resistor string.

In one or more aspects, each of the first output circuit and the second output circuit may include a selection circuit electrically connected to the resistor string and an output buffer electrically connected to the selection circuit.

In one or more aspects, the first node may be electrically connected to an input circuit configured to output the first reference voltage. In one or more aspects, the second node may be electrically connected to a selection circuit configured to output the second reference voltage.

In one or more aspects, the input circuit may include a resistor electrically connected to the first node, a stabilizing capacitor electrically connected to the resistor, an output buffer electrically connected to the resistor, and a selection circuit electrically connected to the output buffer.

According to the one or more example embodiments described herein, a display device can be provided that includes a display panel in which a plurality of subpixels are disposed and on which images representing a plurality of gray levels can be presented, a data driving circuit configured to supply data voltages to the display panel, and a gamma voltage generation circuit configured to supply a plurality of gamma voltages to generate data voltages to the data driving circuit.

In one or more aspects, the gamma voltage generation circuit may include a first node to which a first reference voltage is supplied, a second node to which a second reference voltage is supplied, and a resistor string disposed between the first node and the second node and including a plurality of resistors.

In one or more aspects, respective resistance values of the plurality of resistors may be different from each other, and a difference value between a corresponding resistance value of each of the plurality of resistors and a resistance value of a resistor closest to the corresponding resistor may be a first value.

In one or more aspects, a resistance value of a first resistor closest to the first node among the plurality of resistors may be the smallest among resistance values of the plurality of resistors.

In one or more aspects, a resistance value of a second resistor closest to the second node among the plurality of resistors may be the greatest among the resistance values of the plurality of resistors.

In one or more aspects, a resistance value of a first resistor closest to the first node among the plurality of resistors may be the greatest among resistance values of the plurality of resistors.

In one or more aspects, a resistance value of a second resistor closest to the second node among the plurality of resistors may be the smallest among the resistance values of the plurality of resistors.

In one or more aspects, difference values between voltage values of the plurality of gamma voltages may have a linear relationship with respective gray levels corresponding to the plurality of gamma voltages.

In one or more aspects, the gamma voltage generation circuit may include a first output circuit configured to output a first gamma voltage and electrically connected to the resistor string, and a second output circuit configured to output a second gamma voltage and electrically connected to the resistor string.

In one or more aspects, each of the first output circuit and the second output circuit may include a selection circuit electrically connected to the resistor string and an output buffer electrically connected to the selection circuit.

In one or more aspects, the first node may be electrically connected to an input circuit configured to output the first reference voltage, and the second node may be electrically connected to a selection circuit configured to output the second reference voltage.

In one or more aspects, the input circuit may include a resistor electrically connected to the first node, a stabilizing capacitor electrically connected to the resistor, an output buffer electrically connected to the resistor, and a selection circuit electrically connected to the output buffer.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the principles described herein may be applied to other embodiments and applications without departing from the scope of the present disclosure. The above description and the accompanying drawings provide an example of the technical idea of the present disclosure for illustrative purposes only. That is, the disclosed embodiments are intended to illustrate the scope of the technical idea of the present disclosure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display device comprising:
a display panel in which a plurality of subpixels are disposed and on which images representing a plurality of gray levels are presented;
a data driving circuit configured to supply data voltages to the display panel; and
a gamma voltage generation circuit configured to supply a plurality of gamma voltages to generate data voltages to the data driving circuit,
wherein difference values between the plurality of gamma voltages have a linear relationship with respective gray levels corresponding to the plurality of gamma voltages.

2. The display device of claim 1, wherein the gamma voltage generation circuit comprises a first node to which a first reference voltage is supplied, a second node to which a second reference voltage is supplied, and a resistor string disposed between the first node and the second node and comprising a plurality of resistors, and
wherein respective resistance values of the plurality of resistors are different from each other, and a difference value between a corresponding resistance value of each of the plurality of resistors and a resistance value of a resistor closest to the corresponding resistor is a first value.

3. The display device of claim 2, wherein a resistance value of a first resistor closest to the first node among the plurality of resistors is the smallest among resistance values of the plurality of resistors, and a resistance value of a second resistor closest to the second node among the plurality of resistors is the greatest among the resistance values of the plurality of resistors.

4. The display device of claim 2, wherein a resistance value of a first resistor closest to the first node among the plurality of resistors is the greatest among resistance values of the plurality of resistors, and a resistance value of a second resistor closest to the second node among the plurality of resistors is the smallest among the resistance values of the plurality of resistors.

5. The display device of claim 2, wherein the gamma voltage generation circuit comprises:
a first output circuit configured to output a first gamma voltage and electrically connected to the resistor string; and
a second output circuit configured to output a second gamma voltage and electrically connected to the resistor string.

6. The display device of claim 5, wherein each of the first output circuit and the second output circuit comprises a selection circuit electrically connected to the resistor string and an output buffer electrically connected to the selection circuit.

7. The display device of claim 5, wherein the first node is electrically connected to an input circuit configured to output the first reference voltage, and the second node is electrically connected to a selection circuit configured to output the second reference voltage.

8. The display device of claim 7, wherein the input circuit comprises a resistor electrically connected to the first node, a stabilizing capacitor electrically connected to the resistor, an output buffer electrically connected to the resistor, and the selection circuit electrically connected to the output buffer.

9. The display device of claim 1, wherein the gamma voltage generation circuit supplies the plurality of gamma voltages to the data driving circuit.

10. A display device comprising:
a display panel in which a plurality of subpixels are disposed and on which images representing a plurality of gray levels are presented;
a data driving circuit configured to supply data voltages to the display panel; and
a gamma voltage generation circuit configured to supply a plurality of gamma voltages to generate data voltages to the data driving circuit,
wherein the gamma voltage generation circuit comprises a first node to which a first reference voltage is supplied, a second node to which a second reference voltage is supplied, and a resistor string disposed between the first node and the second node and comprising a plurality of resistors, and
wherein respective resistance values of the plurality of resistors are different from each other, and a difference value between a corresponding resistance value of each of the plurality of resistors and a resistance value of a resistor closest to the corresponding resistor is a first value.

11. The display device of claim 10, wherein a resistance value of a first resistor closest to the first node among the plurality of resistors is the smallest among resistance values of the plurality of resistors, and a resistance value of a second resistor closest to the second node among the plurality of resistors is the greatest among the resistance values of the plurality of resistors.

12. The display device of claim 10, wherein a resistance value of a first resistor closest to the first node among the plurality of resistors is the greatest among resistance values of the plurality of resistors, and a resistance value of a second resistor closest to the second node among the plurality of resistors is the smallest among the resistance values of the plurality of resistors.

13. The display device of claim 10, wherein difference values between the plurality of gamma voltages have a linear relationship with respective gray levels corresponding to the plurality of gamma voltages.

14. The display device of claim 10, wherein the gamma voltage generation circuit comprises:
a first output circuit configured to output a first gamma voltage and electrically connected to the resistor string; and
a second output circuit configured to output a second gamma voltage and electrically connected to the resistor string.

15. The display device of claim 14, wherein each of the first output circuit and the second output circuit comprises a selection circuit electrically connected to the resistor string and an output buffer electrically connected to the selection circuit.

16. The display device of claim 14, wherein the first node is electrically connected to an input circuit configured to output the first reference voltage, and the second node is electrically connected to a selection circuit configured to output the second reference voltage.

17. The display device of claim 16, wherein the input circuit comprises a resistor electrically connected to the first node, a stabilizing capacitor electrically connected to the resistor, an output buffer electrically connected to the resistor, and a selection circuit electrically connected to the output buffer.
